(19) United States
(12) Patent Application Publication
(10) Pub. No.: US 2006/0251066 A1
(43) Pub. Date: Nov. 9, 2006

(54) Terminal routing identity as user identity for UICC-less terminals

(75) Inventors: Joanna Uusikartano, Espoo (FI); Jan Kall, Espoo (FI); Seppo Kuorelahti, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/221,976

(22) Filed: Sep. 9, 2005

(30) Foreign Application Priority Data
May 9, 2005 (GB) 0509429.7
May 10, 2005 (GB) 0509530.2

(51) Int. Cl. H04L 12/56

(52) U.S. Cl. 370/389; 370/401

(57) ABSTRACT

A terminal for use with a wireless local area network, said terminal being arranged to use at least part of at least one of the following pieces information as an identity: a MAC Medium Access Control address of an AP access point to which said terminal is connected to, in use; a MAC address of said terminal; a signal line identifier of a fixed line that said terminal is connected to in use either directly or via a WLAN access point AP; and a switch or router port number of a fixed line that said terminal is connected to, in use, either directly or via a WLAN access point AP.

### FIELD OF THE INVENTION

The invention relates to a terminal.

### DESCRIPTION OF THE RELATED ART

A communication system can be seen as a facility that enables communication sessions between two or more entities such as user equipment and/or other nodes associated with the communication system. The communication may comprise, for example, communication of voice, data, multimedia and so on. A session may, for example, be a telephone call between users or multi-way conference session, or a communication session between user equipment and an application server (AS), for example a service provider server. The establishment of these sessions generally enables a user to be provided with various services.

A communication system typically operates in accordance with a given standard or specification which sets out what the various entities associated with the communication system are permitted to do and how that should be achieved. For example, the standard or specification may define if the user, or more precisely, user equipment is provided with a circuit switched service and/or a packet switched service. Communication protocols and/or parameters which shall be used for the connection may also be defined. In other words, a specific set of “rules” on which the communication can be based on needs to be defined to enable communication by means of the system.

Communication systems providing wireless communication for user equipment are known. An example of the wireless systems is the public land mobile network (PLMN) and another example is the wireless local area network (WLAN). Fixed broadband access is another type of access.

The term “service” used above and hereinafter will be understood to broadly cover any service or goods which a user may desire, require or be provided with. The term also will be understood to cover the provision of complimentary services. In particular, but not exclusively, the term “service” will be understood to include Internet protocol multimedia IM services, conferencing, telephony, gaming, rich

An example of the services that may be offered for users such as the subscribers to a communication system are the so called multimedia services. Some of the communication systems enabled to offer multimedia services are known as Internet Protocol (IP) Multimedia networks. IP Multimedia (IM) functionalities can be provided by means of an IP Multimedia Core Network (CN) subsystem, or briefly IP Multimedia subsystem (IMS). The IMS includes various network entities for the provision of the multimedia services. The IMS services are intended to offer, among other services, IP connections between mobile user equipment.

IP Multimedia connections in IMS will be used more and more for voice calls in the future. To be able to provide full voice services, IMS also has to fulfil regulatory requirements, and thus it needs to be possible to make IMS emergency sessions. IMS emergency sessions in turn have a requirement that emergency calls must be allowed to proceed even without a UICC (universal integrated circuit card) or a (U)SIM (Universal Subscriber Identity Module) card or if the UICC is blocked from usage (due to unpaid bills or the like).

When there is no UICC in the terminal, there is no IMSI (International Mobile Subscriber Identity) available, but there is still a need to identify the terminal in the network. In the IMS emergency technical specification currently proposed TR [23.867v0.9.0], at least part of the IMEI International Mobile station Equipment Identity is used.

However, IMS emergency sessions also have to be made over other IP-CAN (IP-Connectivity Access Network) than GPRS. For WLAN (wireless local area network) and NGN (next generation network) access, no identity has been standardised in case there is no UICC available. For WLAN and NGN, there may not be any IMEI for the terminal that can be used as in the GPRS access case.

Embodiments of the present invention aim to address this.

### SUMMARY OF THE INVENTION

Various aspects of the present invention can be seen from the appended claims.

### BRIEF DESCRIPTION OF THE DRAWINGS

For better understanding of the invention, reference will now be made by way of example to the accompanying drawings in which:

FIG. 1 shows a communication system wherein the invention may be embodied;

FIG. 2 shows a signal flow in embodiments of the invention; and

FIG. 3 shows scenarios in which embodiments of the invention may be used.

### DETAILED DESCRIPTION OF THE PREFERRED EMBODIMENTS

Embodiments of the present invention relate particularly but not exclusively to IMS networks. Embodiments of the invention may be applicable to other networks.

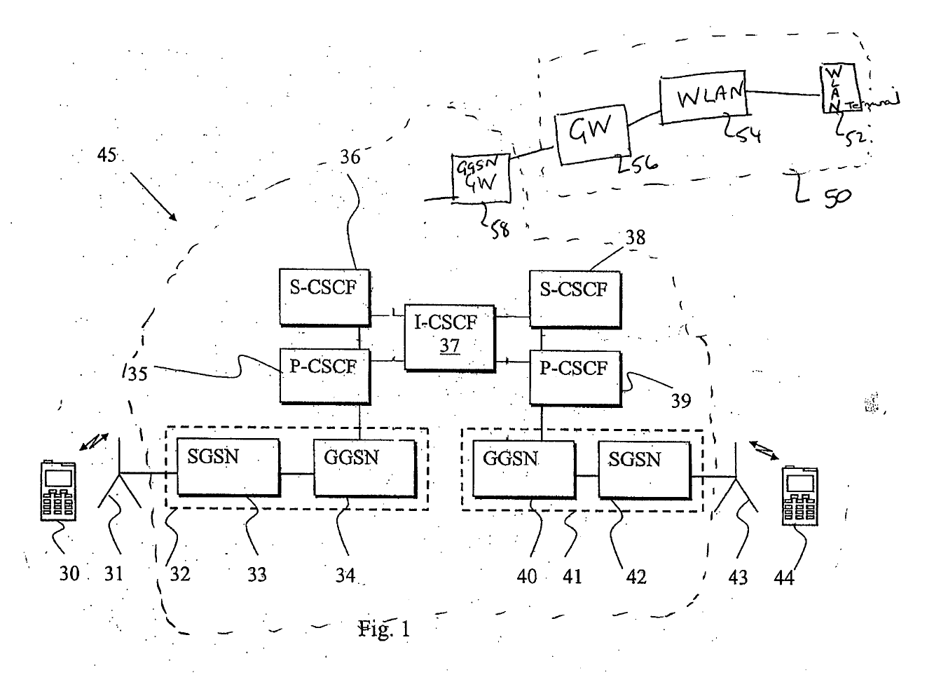

Reference is made to FIG. 1 which shows an IP Multimedia Network 45 for offering IP multimedia services for IP Multimedia Network subscribers. IP Multimedia (IM) functionalities can be provided by means of a Core Network (CN) subsystem including various entities for the provision of the service.

Base stations 31 and 43 are arranged to transmit signals to and receive signals from mobile user equipment 30 and 44 of mobile users i.e. subscribers via a wireless interface. Correspondingly, each of the mobile user equipment is able to transmit signals to and receive signals from the base station via the wireless interface. In the simplified presentation of FIG. 1, the base stations 31 and 43 belong to different radio access networks (RAN). In the shown arrangement each of the user equipment 30, 44 may access the IMS network 45 via the two access networks associated with base stations 31 and 43, respectively. It shall be appreciated that, although, for clarity, FIG. 1 shows the base stations of only two radio access networks, a typical mobile communication network usually includes a number of radio access networks.

The 3G radio access network (RAN) is typically controlled by appropriate radio network controller (RNC). This controller is not shown in order to enhance clarity. A controller may be assigned for each base station or a controller can control a plurality of base stations. Solutions wherein controllers are provided both in individual base stations and in the radio access network level for controlling a plurality of base stations are also known. It shall thus be appreciated that the name, location and number of the network controllers depends on the system.

The mobile user may use any appropriate mobile device adapted for Internet Protocol (IP) communication to connect the network. For example, the mobile user may access the cellular network by means of a Personal computer (PC), Personal Data Assistant (PDA), mobile station (MS) and so on. The following examples are described in the context of mobile stations.

One skilled in the art is familiar with the features and operation of a typical mobile station. Thus, a detailed explanation of these features is not necessary. It is sufficient to note that the user may use a mobile station for tasks such as for making and receiving phone calls, for receiving and sending data from and to the network and for experiencing e.g. multimedia content. A mobile station is typically provided with processor and memory means for accomplishing these tasks. A mobile station may include antenna means for wirelessly receiving and transmitting signals from and to base stations of the mobile communication network. A mobile station may also be provided with a display for displaying images and other graphical information for the user of the mobile user equipment. Speaker means may are also be provided. The operation of a mobile station may be controlled by means of an appropriate user interface such as control buttons, voice commands and so on.

It shall be appreciated that although only two mobile stations are shown in FIG. 1 for clarity, a number of mobile stations may be in simultaneous communication

The core network (CN) entities typically include various control entities and gateways for enabling the communication via a number of radio access networks and also for interfacing a single communication system with one or more communication system such as with other cellular systems and/or fixed line communication systems. In FIG. 1 serving GPRS support nodes 33, 42 and gateway GPRS support nodes 34, 40 are for provision of support for GPRS services 32, 41, respectively, in the network.

The radio access network controller is typically connected to an appropriate core network entity or entities such as, but not limited to, the serving general packet radio service support nodes (SGSN) 33 and 42. Although not shown, each SGSN typically has access to designated subscriber database configured for storing information associated with the subscription of the respective user equipment.

User equipment within the radio access network may communicate with a radio network controller. The radio access network controller is in communication with the serving GPRS support node via an appropriate interface, for example on an Iu interface.

The serving GPRS support node, in turn, typically communicates with a gateway GPRS support node via the GPRS backbone network 32, 41. This interface is commonly a switched packet data interface. The serving GPRS support node and/or the gateway GPRS support node are for provision of support for GPRS services in the network.

The user equipment 30, 44 may connect, via the GPRS network, to application servers that are generally connected to the IMS.

The communication systems have developed such that services may be provided for the user equipment by means of various functions of the network that are handled by network entities known as servers. For example, in the current third generation (3G) wireless multimedia network architectures it is assumed that several different servers are used for handling different functions. These include functions such as the call session control functions (CSCFs). The call session control functions may be divided into various categories such as a proxy call session control function (P-CSCF) 35 and 39, interrogating call session control function (I-CSCF) 37, and serving call session control function (S-CSCF) 36 and 38. A user who wishes to use services provided by an application server via the IMS system may need to register with a serving control entity. The serving call session control function (S-CSCF) may form in the 3G IMS arrangements the entity a user needs to be registered with in order to be able to request for a service from the communication system. The CSCFs may define an IMS network of a UMTS system.

It shall be appreciated that similar function may be referred to in different systems with different names. For example, in certain applications the CSCFs may be referenced to as the call state control functions.

It should be appreciated that while embodiments of the invention have been described in relation to user equipment such as mobile stations, embodiments of the invention are applicable to any other suitable type of user equipment. In this document the term, terminal is intended to cover all the examples of user equipment described.

Also shown in FIG. 1 is a WLAN system 50. A WLAN terminal 52 is connected to a WLAN system 54 and in particular to an access point thereof. A gateway 56 is provided for connection to an external network, for example network 45. The gateway 56 may be connected to a GGSN 58 of the network 58 which will be connected to various elements as already discussed but which are omitted from the figure for clarity. The connection between the gateways 56 and 58 may be via the Internet or the like.

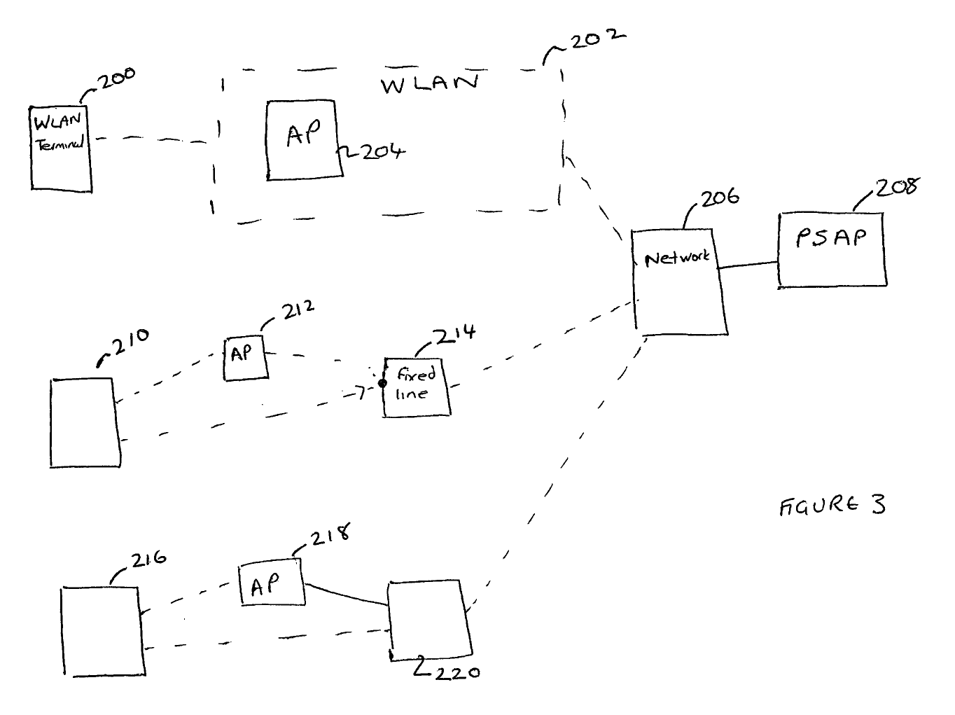

One possible embodiment of this invention has a WLAN terminal or a fixed broadband terminal that is used for establishing an emergency session, even though the terminal does not carry a valid user identity module, e.g. the UICC card with USIM functionality described in 3GPP or when the identity module is blocked from usage by the operator for some reason. This technique may be, where applicable, be used with GPRS terminals. A system in which various embodiments of the invention can be implemented is shown schematically in FIG. 3. In this system, IMS services can be offered to terminals which are connected to a data network using WLAN access or fixed broadband access.

A first terminal 200 is a WLAN terminal and is connected to a WLAN 202 and in particular to an access point 204 thereof. The WLAN is connected to a network 206, for example an IMS network which is in turn connected to the PSAP (public service attachment point).

A second terminal 210 can be connected to a fixed line 214, which may be provided as part of broadband access. The second terminal can be a WLAN terminal or a fixed broadband terminal. The connection to the fixed line may be via an access point 212 or directly. The access point may be part of a WLAN. The fixed line 214 may be connected to network 206.

A third terminal 216 may be connected via an access point 218 or directly to a switch or router 220. The router may be connected to network 206.

It should be appreciated that the arrangement shown in FIG. 3 is schematic and in practice various additional elements may be provided between the different elements shown. Different ones of the terminals may be connected to different networks instead of the single network 206 shown in FIG. 3. More than one network may be connected to the same PSAP. More than one PSAP may be connected to the same network.

According to an embodiment of the invention the terminal shall create the temporary identifier to be used in the emergency session based on at least one of the following information elements:

The MAC Medium Access Control address of the AP access point the terminal is connected to

The MAC address of the terminal itself

The xDSL digital signal line identifier of the fixed line that the terminal is connected to either directly or via a WLAN AP.

The switch or router port number of the fixed line that the terminal is connected to either directly or via a WLAN AP.

At least part of the current location information of the terminal, expressed in geographical coordinates, civil address, geographical shape as specified by 3GPP, or other geographical information which is related to the current location of the terminal.

An identifier constructed by combining any one or more of the above information elements, the whole information element or only some part of the information element in question

The identifier may be used as a user identity or for service applications on the application layer.

The identity may be is an application terminal identity used for service applications on the application layer, such as emergency services.

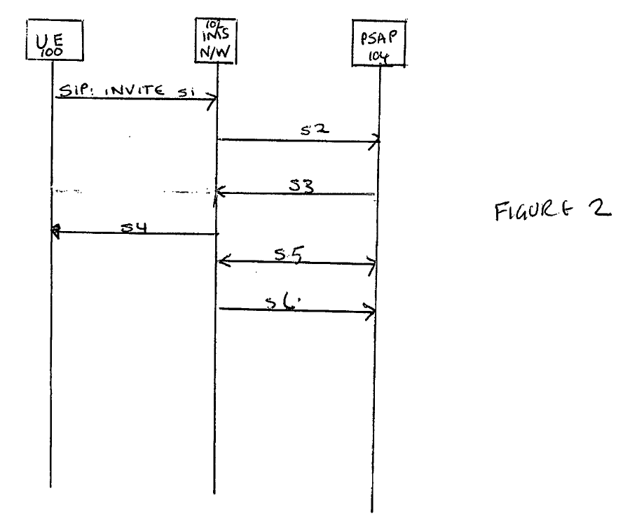

Reference is made to FIG. 2 which shows how embodiments of the invention may be implemented. The terminal 100 shall include this temporary identity in the SIP INVITE sent to the IMS network 102 in step S1.

The IMS network 102 in step S2 shall use this identifier when forwarding the emergency session to the appropriate emergency centre or Public Service Attachment Point (PSAP) 104.

In steps S3 and S4, the PSAP/emergency centre 104 may use this temporary identity in case the original emergency session is disconnected for some reason in order to initiate a new emergency session, in other words to re-establish the emergency session with the same terminal. In particular, the PSAP sends a message to the IMS network including the temporary identity. Based on this temporary identity, the IMS network is able to establish a connection in step S4 with the terminal.

The PSAP/emergency centre may also use the temporary identifier to request further information about the terminal from IMS (and from the access network), for example in step S5. Such information may be for example about the current location of the terminal or historical data the IMS may store regarding this terminal e.g. regarding routing history or lost connections history. This information may be returned by the IMS network to the PSAP in step S6.

It should be appreciated that steps S3 and S4 are only required if a connection needs to be established by the PSAP 104 and accordingly these steps may be carried out at any appropriate time and not just as shown in FIG. 2.

Likewise, steps S5 and S6 may be carried out only if the PSAP requires certain information. The timing of these steps may be varied and may not just be as shown in FIG. 2. It should be appreciated that several requests may be sent by the PSAP at varying times. The requested information may be returned in one or more responses by the IMS. Likewise the PSAP may send one request and receive one or more responses from the IMS in response to that one request.

In some embodiments of the invention, the IMS may in response to a request from the PSAP send a request to the terminal itself or a different entity in order to obtain the required information for responding to the PSAP.

When using lower layer routing identities to identify the user that is making the call, it to some extent breaks the layered model, as a lower layer identity is used as an identifier or part of a terminal identifier on upper layers. The advantage is that this type of information is typically available in the terminal and it is possible for the terminal to construct a temporary identity, which is very likely to be globally unique, using these information elements.

In one embodiment of the invention, the terminal IP address may be used at least partially or in its entirety in combination or on its own.

It is also noted herein that while the above describes exemplifying embodiments of the invention, there are several variations and modifications which may be made to the disclosed solution without departing from the scope of the invention as defined in the appended claims.

1. A terminal for use with a wireless local area network, said terminal configured to use at least part of a MAC medium access control address as an identity.

2. A terminal as claimed in claim 1, wherein said identity is a user identity.

3. A terminal as claimed in claim 1, wherein said identity is used for service applications on an application layer of the network.

4. A terminal as claimed in claim 1, wherein said identity is an application terminal identity used for service applications on an application layer of the network.

5. A terminal as claimed in claim 3, wherein said identity is used for emergency services.

6. A terminal as claimed in claim 1, wherein said address is the MAC address of at least one of the terminal and an access point to which the terminal is connected in use.

7. A terminal for use with a wireless local area network, said terminal configured to use at least part of information identifying a fixed line to which said terminal is coupled in use.

8. A terminal as claimed in claim 7, wherein said information is least one of:
an DSL line identifier, a switch identifier, a router identifier, a switch port, and a router port.

9. A terminal as claimed in claim 7, wherein said information is at least part of a current location information of the terminal, expressed in geographical coordinates, civil address, geographical shape as specified by 3GPP, or other geographical information which is related to a current location of the terminal.

10. A terminal as claimed in claim 7, wherein said terminal is configured to be connected directly to said fixed line.

11. A terminal as claimed in claim 7, wherein said terminal is configured to be connected to said fixed line via an access point.

12. A terminal as claimed in claim 11, wherein said access point comprises a WLAN access point.

13. A terminal for use with a wireless local area network (WLAN), said terminal configured to use at least part of at least one of the following pieces information as an identity:
a MAC Medium Access Control address of an AP access point to which said terminal is connected to during use;
a MAC address of said terminal;
a line identifier of a fixed line that said terminal is connected to during use either directly or via a WLAN access point AP;
a switch or router port number of said fixed line that said terminal is connected to during use either directly or via said WLAN access point AP; and
location information expressed in geographical coordinates, civil address, geographical shape, or other geographical information which is related to the current location of the terminal.

14. A terminal as claimed claim 13, wherein said terminal is one of a GPRS terminal, a WLAN terminal, and a fixed broadband terminal.

15. A terminal as claimed in claim 13, wherein said terminal is configured to obtain said at least part of at least one of said pieces of information from one of an access point, a fixed line, a switch or a router and to use said information to determine said identity.

16. A system, comprising:
a terminal for use with a wireless local area network, said terminal configured to use at least part of a MAC medium access control address as an identity; and
a network to which said terminal is attachable.

17. A system as claimed in claim 16, further comprising:
an access point to which said terminal is attachable, said access point configured to be connected to said network.

18. A system as claimed in claim 16, further comprising:
at least one of a router and a switch to which said terminal is attachable, said at least one router and switch configured to be connected to said network.

19. A system as claimed in claim 16, further comprising:
an emergency centre configured to have an emergency session with said terminal.

20. A system, comprising:
a terminal for use with a wireless local area network (WLAN), said terminal configured to use at least part of at least one of the following pieces information as an identity:
a MAC Medium Access Control address of an AP access point to which said terminal is connected to during use,
a MAC address of said terminal,
a line identifier of a fixed line that said terminal is connected to during use either directly or via a WLAN access point AP,
a switch or router port number of said fixed line that said terminal is connected to during use either directly or via said WLAN access point AP, and
location information expressed in geographical coordinates, civil address, geographical shape, or other geographical information which is related to the current location of the terminal; and
a network to which said terminal is attachable.

21. An emergency centre configured to establish a session with a terminal using an identity associated with said terminal, said identity comprising at least one of the following
a MAC Medium Access Control address of an AP access point to which said terminal is connected to during use,
a MAC address of said terminal,
a signal line identifier of a fixed line that said terminal is connected to during use either directly or via a WLAN access point AP,
a switch or router port number of said fixed line that said terminal is connected to during use, either directly or via said WLAN access point AP, and
location information expressed in geographical coordinates, civil address, geographical shape, or other geographical information which is related to the current location of the terminal.

22. An emergency centre configured to request information from a terminal with which an emergency session is established, using an identity associated with said terminal, said identity comprising at least one of the following
a MAC Medium Access Control address of an AP access point to which said terminal is connected to during use,
a MAC address of said terminal,
a signal line identifier of a fixed line that said terminal is connected to during use either directly or via a WLAN access point AP,
a switch or router port number of said fixed line that said terminal is connected to during use, either directly or via said WLAN access point AP, and
location information expressed in geographical coordinates, civil address, geographical shape as specified by 3GPP, or other geographical information which is related to the current location of the terminal.

23. An emergency centre as claimed in claim 22, wherein said information comprises at least one of the current location of the terminal, routing history, and lost connections history.

24. A network configured to receive identity information associated with a terminal and to forward said information to an entity with which a session is to be established, said identity information comprising at least one of the following
a MAC Medium Access Control address of an AP access point to which said terminal is connected to during use,
a MAC address of said terminal,
a signal line identifier of a fixed line that said terminal is connected to during use either directly or via a WLAN access point AP,
a switch or router port number of said fixed line that said terminal is connected to during use, either directly or via said WLAN access point AP, and
location information expressed in geographical coordinates, civil address, geographical shape, or other geographical information which is related to the current location of the terminal.

25. A network as claimed in claim 24, wherein said network is an IMS network.

26. A network as claimed in claim 24, wherein said entity is one of an emergency centre and a PSAP.

27. A network as claimed in claim 24, wherein said network is arranged to store information in association with said identity.

28. A network as claimed in claim 27, wherein said information comprises at least one of connection history, dropped connections history, and location information.

29. A network element configured to receive identity information associated with a terminal and to forward said identity information to a network with which a session is to be established, said identity information comprising at least one of the following
a MAC Medium Access Control address of an AP access point to which said terminal is connected to during use,
a MAC address of said terminal,
a signal line identifier of a fixed line that said terminal is connected to during use either directly or via a WLAN access point AP,
a switch or router port number of said fixed line that said terminal is connected to during use, either directly or via said WLAN access point AP, and
location information expressed in geographical coordinates, civil address, geographical shape, or other geographical information which is related to the current location of the terminal.

30. A network element as claimed in claim 29, wherein said network element comprises at least one of an access point, a switch, a router, and a fixed line.

31. A network element as claimed in claim 29, wherein said network element is configured to provide at least part of said identity information used by said terminal.

32. A method of establishing an emergency session comprising the steps of:
defining identity information associated with a terminal, said identity information comprising at least one of the following
a MAC Medium Access Control address of an AP access point to which said terminal is connected to during use,
a MAC address of said terminal,
a signal line identifier of a fixed line that said terminal is connected to during use either directly or via a WLAN access point AP,
a switch or router port number of said fixed line that said terminal is connected to during use, either directly or via said WLAN access point AP, and
location information expressed in geographical coordinates, civil address, geographical shape, or other geographical information which is related to the current location of the terminal; and
forwarding said information to an entity with which the emergency session is to be established.
